(19) United States
(12) Patent Application Publication
(10) Pub. No.: US 2024/0404085 A1
(43) Pub. Date: Dec. 5, 2024

(54) SYSTEMS AND METHODS FOR USER INTERFACES WITH MANUAL GEOSPATIAL CORRELATION

(71) Applicant: Palantir Technologies Inc., Denver, CO (US)

(72) Inventor: Daniel Zangri, Austin, TX (US)

(21) Appl. No.: 18/676,755

(22) Filed: May 29, 2024

Related U.S. Application Data
(60) Provisional application No. 63/546,880, filed on Nov. 1, 2023.
(60) Provisional application No. 63/469,928, filed on May 31, 2023.

(51) Int. Cl. G06T 7/292; G01S 13/66; G01S 15/06; G01S 17/06; G01S 19/03

(52) U.S. Cl. CPC G06T 7/292; G01S 13/66; G01S 15/06; G01S 17/06; G01S 19/03

(57) ABSTRACT

Systems and methods for correlating data (e.g., sensor data) with entities and/or tracking entities are provided. In some embodiments, a method includes displaying one or more indications of one or more entities, receiving a first input to select the target entity from the one or more entities, in response to receiving the first input, displaying an interactive element for associating one or more sensors to the target entity, displaying the one or more sensors that are active, receiving a second input associated with the interactive element, in response to receiving the second input, creating a link between the target entity and at least one sensor of the one or more sensors, and updating one or more entity properties of the target entity based on sensor data of the at least one sensor and the created link.

### CROSS REFERENCE TO RELATED APPLICATIONS

This application claims priority to U.S. Provisional Application No. 63/546,880, filed Nov. 1, 2023, and U.S. Provisional Application No. 63/469,928, filed May 31, 2023, each of which is incorporated by reference herein for all purposes.

### TECHNICAL FIELD

Certain embodiments of the present disclosure are directed to correlating data (e.g., sensor data) with entities. More particularly, some embodiments of the present disclosure provide systems and methods for correlating data (e.g., sensor data) with entities via interactive maps.

### BACKGROUND

Large streams of data are captured to generate a map that provides representation of an area. Multiple sensors may be used to collect information of multiple entities in the area. In some cases, multiple sensor data may represent (e.g., associate with) the same entity. Hence it is desirable to improve the techniques for correlating data (e.g., sensor data) of different types that in reality represents the same entity.

### SUMMARY

Certain embodiments of the present disclosure are directed to correlating data (e.g., sensor data) with entities. More particularly, some embodiments of the present disclosure provide systems and methods for correlating data (e.g., sensor data) with entities via interactive maps.

According to some embodiments, a method for tracking a target entity includes displaying one or more indications of one or more entities, receiving a first input to select the target entity from the one or more entities, in response to receiving the first input, displaying an interactive element for associating one or more sensors to the target entity, displaying the one or more sensors that are active, receiving a second input associated with the interactive element, in response to receiving the second input, creating a link between the target entity and at least one sensor of the one or more sensors, and updating one or more entity properties of the target entity based on sensor data of the at least one sensor and the created link. The method is performed using one or more processors.

According to certain embodiments, a computing device for generating and managing a security level-aware map comprises a processor and a memory having a plurality of instructions stored thereon that, when executed by the processor, causes the computing device to display one or more indications of one or more entities, receive a first input to select the target entity from the one or more entities, in response to the first input, display an interactive element for associating one or more sensors to the target entity, display the one or more sensors that are active, receive a second input associated with the interactive element, in response to the second input, create a link between the target entity and at least one sensor of the one or more sensors, and update one or more entity properties of the target entity based on sensor data of the at least one sensor and the created link.

According to some embodiments, a method for tracking a target entity includes monitoring sensor data received from one or more sensors to detect the target entity among one or more entities, in response to the detection of an entity similar to the target entity based on sensor data received from at least one sensor of the one or more sensors, providing a notification indicating that the entity similar to the target entity has been detected, receiving a first input confirming that the detected entity is the target entity, in response to receiving the first input, displaying an interactive element for associating one or more sensors to the target entity, displaying the one or more sensors that are active, receiving a second input associated with the interactive element, in response to receiving the second input, creating a link between the target entity and at least one sensor of the one or more sensors, and updating one or more entity properties of the target entity based on sensor data of the at least one sensor and the created link

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a system for streaming, storing, and processing real-time data according to certain embodiments of the present disclosure.

FIG. 2 is a simplified diagram showing a computing system for implementing one or more components or all components of the system for streaming, storing, and processing real-time data in accordance with at least one example set forth in the disclosure.

FIG. 3 illustrates an example diagram for entities according to some embodiments of the present disclosure.

FIG. 4 is a simplified diagram showing a method for tracking a target entity by associating with sensor data according to one embodiment of the present disclosure.

FIG. 5 is a simplified diagram showing a method for identifying and tracking a target entity by associating with sensor data according to one embodiment of the present disclosure.

FIG. 6 is a simplified diagram showing an exemplary screenshot of a display screen for displaying and tracking one or more entities according to one embodiment of the present disclosure.

FIG. 7 is a simplified diagram showing a method for tracking an entity by creating a link between the entity and one or more sensors according to one embodiment of the present disclosure.

### DETAILED DESCRIPTION

Large streams of data are captured to generate a map that provides representation of an area. Multiple sensors may be used to collect information of multiple entities in the area. In some cases, multiple sensor data may represent (e.g., associate with) the same entity. Hence it is desirable to improve the techniques for correlating data (e.g., sensor data) of different types that in reality represents the same entity.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

In certain embodiments, as high-scale, real-time data become increasingly common and vital to certain user workflows, analytical features that display and process that data have become important parts of users' tools. As an example, in operational use-cases, live location and signals data usually are the bread-and-butter of creating a trustworthy and seamless shared understanding of an area, which ultimately, for examples, allows users to quickly and safely react to complex situations.

In some embodiments, a system (e.g., a backend system) for streaming, storing, and processing real-time data is provided. For example, the system (e.g., the backend system) for streaming, storing, and processing real-time data is built using one or more storage layers, one or more computation layers, and/or one or more query layers to serve as a fast and/or horizontally-scalable solution for different shapes and/or sizes of real-time data.

According to certain embodiments, the system may use one or more computing models to process the high-scale, real-time data (e.g., real-time geospatial data). In certain embodiments, a computing model, also referred to as a model, includes a model to process data. In certain embodiments, a model includes, for example, an AI model, a machine learning (ML) model, a deep learning (DL) model, an image processing model, an algorithm, a rule, other computing models, a large language model (LLM), and/or a combination thereof. In certain embodiments, systems and methods of the present disclosure are directed to generating a text summary from one or more event logs containing unstructured and/or structured data using one or more LLMs.

According to certain embodiments, a language model is a computing model that can predict the probability of a series of words, for example, based on the text corpus on which it is trained. In some embodiments, a language model can infer word probabilities from context. In some embodiments, a language model can generate word combinations (and/or sentences) that are coherent and contextually relevant. In certain embodiments, a language model can use a computing model that has been trained to process, understand, generate, and manipulate language. In some embodiments, a language model can be useful for natural language processing, including receiving natural language prompts and providing natural language responses, speech recognition, natural language understandings, and/or the like. In certain embodiments, a language model includes an n-gram, exponential, positional, neural network, and/or other type of model.

According to some embodiments, a large language model (“LLM”) is a type of language model that has been trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

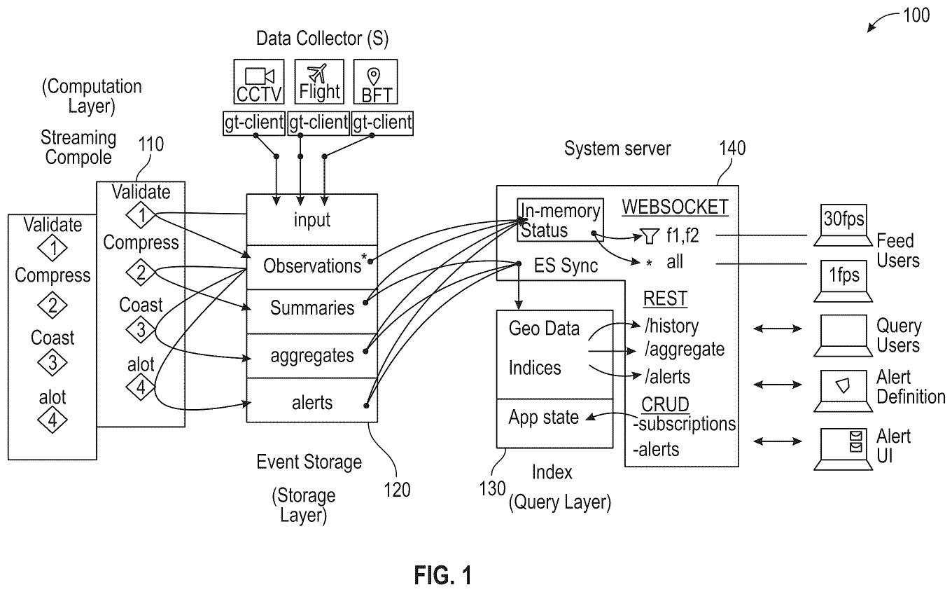

FIG. 1 is a simplified diagram showing a system for streaming, storing, and processing real-time data according to certain embodiments of the present disclosure. This diagram is merely an example. One of ordinary skill in the art would recognize many variations, alternatives, and modifications. For example, the system 100 for streaming, storing, and processing real-time data includes a computation layer 110, a storage layer 120, a query layer 130, and a system server 140. Although the above has been shown using a selected group of components for the system for streaming, storing, and processing real-time data, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present disclosure.

In some examples, the system 100 (e.g., a backend system) for streaming, storing, and processing real-time data is configured to perform one or more or all of the following tasks:
1. Provide a low-latency system for streaming real-time location data according to certain embodiments.
2. Provide a system for querying and/or aggregating historical location data collected for longer-term storage (e.g., with one or more retention controls) according to some embodiments.
3. Provide real-time geofence alerting for data entering the system that meet one more configurable queries according to certain embodiments.
4. Act as a source by which geotemporal series can be referenced from one or more certain objects according to some embodiments.
5. Provide one or more APIs for bulk uploading data to the system's history store according to certain embodiments.

In certain examples, the system 100 (e.g., a backend system) for streaming, storing, and processing real-time data provides two broad paths for data entering the system:
1. Fast path: data entering the system are written to the storage layer 120 according to some embodiments. For example, the computation layer 110 performs basic validation. As an example, the system server 140 sends the data out over any active, relevant data subscription.
2. Slow path: after passing through the fast path, the computation layer 110 performs one or more processing jobs on the data for one or more or all of the following tasks according to certain embodiments:
   a) Data summarization: before the data are stored in the query layer 130 for querying, data are deduplicated by one or more configurable levels of time and distance (e.g., users of the system 100 can determine that for a data type, they wish to only save a single point for a time period of Y length if the entity has moved less than X meters) according to some embodiments.
   b) Alerts: perform real-time alerting, such as when an entity enters and/or exits a user-defined region, according to certain embodiments.
   c) Aggregations: bucketing data by one or more time windows and/or filters to see one or more aggregate views (e.g., one or more histograms) of data flowing through the system 100 according to some embodiments.

In some examples, data entering the system 100 (e.g., a backend system) for streaming, storing, and processing real-time data includes the fields for series identification, entity identification, entity type, position, and timestamp (e.g., date and time). For example, one or more live data subscriptions, one or more history queries, and/or one or more alerts are represented as one or more queries over any of these fields. As an example, the data entering the system 100 (e.g., a backend system) contain one or more extra extension properties as additional metadata.

According to some embodiments, the system 100 (e.g., a backend system) for streaming, storing, and processing real-time data includes a separate integration service for basic real-time and/or bulk upload integrations. For example, the system 100 (e.g., a backend system) also provides a Java client for streaming data to the storage layer 120.

According to certain embodiments, the system 100 (e.g., a backend system) for streaming, storing, and processing real-time data provides a subscription API, a path history API, and an aggregation API. For example, the system 100 (e.g., a backend system) provides basic bulk upload functionality and/or real-time alerting.

According to some embodiments, data from the system 100 (e.g., a backend system) are viewed in one or more or all of the following ways:
a) Live layers
b) Track search
c) AI Aggregations
d) Real-time alerting
e) Track search
f) Track data linked to certain objects

Certain embodiments of the present disclosure include systems and methods for streaming geotemporal data. In some embodiments, stream processing is a fundamentally different paradigm from batch processes for two major reasons: 1) a stream of data can be arbitrarily large (e.g., for practical purposes, infinite); and 2) streams are often time-sensitive and made available to users in real-time. In some embodiments, time becomes a crucial aspect of streaming data. In certain embodiments, large amounts of data (e.g., infinite data) may not be practically stored. For example, a geotemporal data staging stack ingests greater than 40 GB of data every hour. In some examples, while data storage is cheap, at that rate, at most on-premises deployments, storage may be used up in days, if not hours.

In some embodiments, infinite data means the system processing the data cannot wait until all the data is available, then run a batch job. In certain embodiments, time sensitivity means the system can barely wait at all before processing data. For example, some systems demand sub-second (e.g., less than 1 second) latency. In certain embodiments, stream processing platforms have one or more of three parts: 1) an unbounded queue to accept writes from source systems: 2) a streaming data analysis framework that processes records from the queue; and 3) a traditional data store where analysis results get written.

According to certain embodiments, the system 100 includes features of tracking entities (e.g., objects, people, planes, ships, etc.) through time and space to support analytic workflows. For example, the analytic workflows include: showing where this ship has gone this year; and/or listing the planes that landed at this airport this month. In some embodiments, the system can receive streaming geotemporal data with sub-second latencies.

According to some embodiments, an observation refers to a location of an entity (e.g., an object) at a moment in time. In some embodiments, a track refers to a time series of observations. In certain embodiments, a lifecycle of an observation includes an input process, a validation process, and/or an analysis process. In some embodiments, the system includes one or more interactive parts for an observation. For example, the system includes an interface to allow receiving (e.g., writing) an observation (e.g., by a data source system), a communication channel (e.g., a websocket endpoint) that continually serves the latest observations, and/or a software interface (e.g., Conjure API) for building heatmaps, querying an entity's movements, and/or the like.

In some examples, a data structure for an observation includes a seriesType, seriesId and entityId. In certain examples, the seriesId is the unique identifier for the track that contains the observation (e.g., seriesId might be “A-airline997-november-8”). In some examples, the entity Id is the unique identifier of an entity (e.g., “A-enterprise”) and the field can be used to query over the full set of tracks for the ones relevant to a specific entity. In certain examples, the seriesType corresponds to the data source, for example, a ship tracking service.

In certain embodiments, the observation's lifecycle begins with a push from a client source system. For example, a client system writes the observation to a proxy. As an example, the proxy forwards the observation to the tracking service. In some embodiments, the observation is serialized (e.g., Avro JSON). In certain embodiments, a validator job loads the observation, determines whether the observation is valid, and sends the observation (e.g., the serialized observation) to the tracking service based on whether the observation is valid or not. In some embodiments, if the observation is invalid, the observation is sent to a component for error inputs, for example, to determine why the observation is invalid. In certain embodiments, if the observation is valid, the observation is submitted for search indexing operations and/or for communication operations via communication channels (e.g., websockets, websocket APIs (application programming interface), duplex communication channels). In some embodiments, both search indexing and communication operations should be low-latency. In some embodiments, the communication operations have sub-second latencies, whereas search indexing operations can be an order of magnitude slower.

According to some embodiments, the search indexing operations include, for example, reading the valid observation, writing the newest observation for the entity to a search engine periodically (e.g., downsampling, less frequent than the frequency of receiving the observations), serving the observation's track and individual points to search clients by the search engine, and/or the like. In certain embodiments, the system loads the valid observation and checks if any clients have subscribed to updates about the observation (e.g., 22nd fleet). In some embodiments, for each client interested in the observation, the system 100 enqueues the observation. In certain embodiments, after applying some checks and/or analysis (e.g., Is bandwidth available? Does the client already have newer data?), the observation is sent to a client.

According to certain embodiments, the system 100 can be deployed in one or more remote environments (e.g., cloud environments) and/or one or more on-premises environments. In some embodiments, the system 100 can be deployed with single nodes for small form factor on-premises stacks.

According to some embodiments, an observation refers to an event at a single time and place (e.g., a GPS (global position system) ping). In certain embodiments, a track refers to a time series of observations from the same source (e.g., the history of places that a shark wearing a GPS tag has been). In some examples, observations are schematized according to observation specifications. For example, the observation has the following data structure:

| | |
|---|---|
| seriesId | # an integrator-defined stable ID that refers to a track |
| | over time |
| position | # the location of the observation |
| timestamp | # when the Observation took place |
| set<metadata> | |

According to some embodiments, a field in the system is a key-value pair of a name and a typed value. For example, an entity's speed may have field name “speed” and field value of type double. In certain embodiments, a “live field” (e.g., liveFields) is expected to update with each observation in a track. Examples may include speed or heading. In some embodiments, for each timestamp on a track, the system stores the value of that live field. In certain embodiments, a “static field” is not expected to update with each observation in a track. Examples may include a plane's tail number or a ship's callsign. In some embodiments, the system stores the most recent value of a static property. In certain embodiments, the choice of live and static fields, along with their names and types, is configurable in an observation specification.

According to some embodiments, a track is identified by a GID (e.g., global ID). For example, a GID includes geotime-track.<sourceSystemId>.<collectionId>.<observationSpecId>.<seriesId>. In certain embodiments, the GID does not include entityId. In some examples, this is different compared to traditional integrations, where tracks were identified by the unique (seriesId, entity Id) pair.

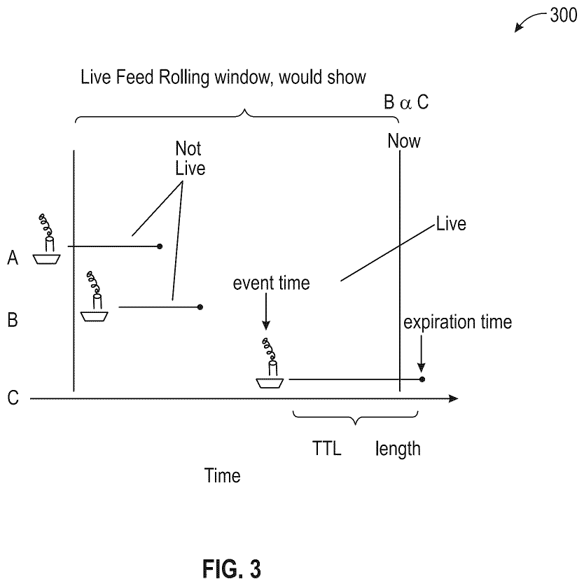

According to certain embodiments, liveness is a special property that is a combination of: when an observation took place (event time); and/or a time-to-live (TTL) time set by the data integrator. FIG. 3 illustrates an example diagram 300 for entities A, B, and C. In the example illustrated in FIG. 3, at current time “now”, only ship C is considered Live, per its event time and the assigned expiration time on integration.

In some embodiments, the system can define a window of time for entities that will continue to update in the future. In certain embodiments, the window of time (e.g., rolling window length) means that the layer will include any data that was live in the past. In some embodiments, this is done via a range query on the expirationTimestamp field for the latest observation in a track.

According to certain embodiments, referring back to FIG. 1, data is integrated into the system 100 via a record extractor, which transforms source data into a desired data format that is then formatted into observations to be streamed to the system 100. In some embodiments, record extractor plugins run within a service (e.g., a geotemporal integration engine (GIE)). In certain embodiments, the GIE supports existing plugins. In some embodiments, the GIE also supports running plugins that are shipped as assets that are packaged from code that lives in exclusive or air-gapped environments. In certain embodiments, the system 100 and/or the GIE supports one or more plugins dynamically loaded and run by a GIE service.

According to some embodiments, the system 100 includes querying integrations. In certain embodiments, once data (e.g., geotemporal data) is received, stored, and/or processed in the system 100, at least two mechanisms through which data can be retrieved via one or more communication layers. In some embodiments, the one or more communication layers include one or more non-vectorized layers (e.g., duplex communication channels, websockets) and one or more vectorized layers.

According to certain embodiments, the one or more non-vectorized layers stream every observation coming from the integration to the client and aim to have low latency (e.g., sub-second latency). In some embodiments, the system 100 should use the one or more non-vectorized layers when the data source has low-cardinality (e.g., 10-100 unique tracks), fast-updating data where smooth updates to data (e.g., updates on a map) are important (e.g., assets flying). In certain embodiments, the system 100 should avoid using non-vectorized layers for high-cardinality or slowly-updating integrations (e.g., identifying vegetation in satellite imagery). In some embodiments, the non-vectorized layers allow data to flow through the system 100 at the lowest possible latency.

According to some embodiments, the one or more vectorized layers, also referred to as vector tiles, query a snapshot of the most recent observation and encode them in a vectorized format for a compact data representation. In certain embodiments, the one or more vectorized layers can support layers containing a large number of observations (e.g., millions of observations) and should be used with high-cardinality and/or slowly-updating integrations (e.g., identifying vegetation in satellite imagery, AIS (automated identification system)). In some embodiments, the system 100 should avoid vector tiles when streaming updates to data (e.g., updates to map) is important (e.g., ISR (intelligence, surveillance and reconnaissance)), since vector tiles update slowly. For example, vector tiles update every 4 seconds at quickest, and every 10 minutes at slowest. In certain embodiments, vector tiles are supported by queries to a search engine (e.g., Elasticsearch). In some examples, data is written into the search engine after applying a down sampling window (e.g., every 30 seconds), and tracks encoded in vector tiles can update at the sampling frequency (e.g., once every 30 seconds) or at a maximum frequency of the sampling frequency.

According to certain embodiments, the system 100 may be exposed to client systems via one or more live layers, which may include, for example, subscriptions, feeds, or enterprise map layers (EMLs), and/or the like. In some embodiments, these can be configured in an administrative application. In certain embodiments, only feeds with data that the user has access to will show up. In some embodiments, one or more feeds can contain multiple observation specifications within them. In some embodiments, if a feed includes observations A and B that matches integrations A and B, but the user only has access to A, the user will still see the feed, but it will only contain data from integration A. In certain embodiments, one or more feeds are always filtered to only contain data the user can see, even if the feed's query itself matches more data. In some embodiments, the system 100 refreshes the list of feeds periodically and/or by a trigger. For example, the system 100 refreshes the list of feeds from the administrative application every minute.

According to some embodiments, the system 100 queries a search engine (e.g., Elasticsearch). In certain embodiments, for every geo-temporal-backed data integration, the system 100 creates multiple search indices (e.g., Elasticsearch indices) to store the data in. For example, one stack can have hundreds, sometimes thousands, of indices. In some embodiments, to query the search engine, the system 100 specifies which indices the search engine should look at for the requested data. In certain embodiments, this can make queries more efficient, and it also addresses the fact that different indices may have different fields. For example, a BAS index and an ISR index have very different schemas.

According to certain embodiments, when the system 100 receives a query, it analyzes the query and determines which observation specifications could match the query. For example, the system may use heuristics like “Does this specification have the fields requested?” or “Does the query mention a particular observation specification?”. In some embodiments, the system 100 may select and/or expand the matching observation specifications into the search indices to search.

According to some embodiments, the system 100 can provide one or more alerts on geotemporal data. In certain embodiments, a geotemporal alert is a query on geotemporal data that notifies users as soon as the query becomes true (e.g., when the alert “fires”). In some embodiments, geotemporal alerting workflows are managed on a configuration user interface (UI). For example, users can configure the alert's backing query (e.g., “alert when AIS data enters the Mediterranean Sea”). As an example, users can configure the query by clicking on a map to represent a geofenced region like the Mediterranean Sea (or any arbitrary shape). In this example, in the same UI, users can configure the alert's notifications. In certain embodiments, this attains low latency by running queries on geotemporal data upstream of the search engine, for example, in a search job.

According to certain embodiments, the system 100 may include one or more types of alerts. In some embodiments, one type of alert is an entity state change alert, which is a type of alert indicating if geotemporal tracks flip from matching the alert query (or a list of queries, which are OR-ed with each other) to not matching, or vice versa. For example, “Fire an alert if AIS track with series ID F leaves the Mediterranean Sea.”

In certain embodiments, one type of alert is a count timestamp alert, which is a type of alert indicating if the number of observations matching the alert query meets a configurable threshold during a fixed time interval. For example, “Fire an alert if more than 10,000 AIS observations enter the Mediterranean Sea between 10:00Z and 12:00Z.”

In some embodiments, one type of alert is a multi-linked entity distance alert, which is a type of alert indicating if all query conditions are satisfied by a set of observations within a given distance of another observation (as defined by another observation query). For example, “Fire an alert if AIS track with series ID F and an ADS-B track with series ID A111 both come within 500 meters of AIS track with series ID B.”

In certain embodiments, one type of alert is a linked entity distance alert, which is a special case of multi-linked entity distance alerts, but only supporting one type of track. For example: “Fire an alert if AIS track with series ID F comes within 500 meters of AIS track with series ID B.”

In some embodiments, one type of alert is a multi-threshold alert, which is a type of alerts indicating if the number of observations (possibly of multiple types) matching the alert query meets a configurable threshold over a sliding time window. This is not to be confused with a count timestamp alert, which is over a fixed time interval. For example: “Fire an alert if more than 10,000 AIS observations and more than 1,000 ADS-B observations enter the Mediterranean Sea in any 60-minute sliding time window.”

In certain embodiments, one type of alert is a threshold alert, which is a special case of multi-threshold alerts, but only supporting one type of track. For example: “Fire an alert if more than 10,000 AIS observations enter the Mediterranean Sea in any 60-minute sliding time window.”

According to some embodiments, the system 100 allows administering integrations. In certain embodiments, integrations are administered from their corresponding source system specification. For example, one or more of the following features of integration can be configured:
Retention (retentionDays): the amount of time for which to retain data from an integration
Index Rollover Period for the search engine (rolloverDays): the period of time you keep per historical ES index
Time-to-Live (ttlMillis): the defined time by which an integrated observation from this integration is considered “active” or “live”
Dedupe Parameters (dedupeTicks): the parameters uses to decide two data successive data points from integration are the same (or close enough where it's only needed to save one, which is useful for integrations that send many data points per second)
ACL (acl): a security level that can be set at the collection or source system level. This sets the required classification and group membership needed to access data from an integration. In certain cases, the system allows for ACLs to be set on the individual track.
Monitors (monitors): configuration for monitors to alert on configured criteria.

In some embodiments, data from each source system is divided into collections, which are integrator-defined subsets of data in a source system (e.g., classified buckets of data and unclassified buckets of data from the same source). In certain embodiments, within each collection, an optional configuration can be specified per observation specification expected in the integration with one or more of the above settings.

In certain examples, retentionDays specifies for how many days data will be kept from a given integration. By default, in some examples, this is set to the global, service-level retention length. In some examples, retentionDays set at the integration-level may supersede the service-level setting. In certain examples, retention is based on the time data is integrated, not the timestamp on the data itself.

In some examples, dedupe parameters (e.g., dedupeTicks) are used to reduce the amount of fast-updating, high-volume data saved when a source is sending more data than is analytically valuable for historical analysis. In certain examples, dedupe only happens on successive Observations within the same track, for example, the path of a single plane within an integration, and only affects how much data is saved for history-it does not affect how much data is sent to subscriptions (e.g., websocket-based subscriptions).

In certain examples, ACLs can be set on the Source system or on a collection to describe the security level of data within that Source system or collection. In some examples, when AC: is set, only users who meet the group and classification criteria will be able to see data from the source system or collection. In certain examples, a user must be working within an Investigation or map (or other artifacts) that has its authorization set at or above the ACL of data from the associated source system that they want to see.

In some examples, monitors can be created on the collection level. In certain examples, the system 100 treats a source system specification level monitor as equivalent to setting the monitor on every collection.

According to some embodiments, the system 100 includes one or more security modes. In certain embodiments, the system 100 supports two security models (e.g., modes), which are separate and mutually exclusive: the integration security model (e.g., integration security mode) and the track-level security (TLS) model (e.g., TLS mode). In some embodiments, the integration security model is accessible and can support a significantly higher scale of data. In certain embodiments, in this security model, each observation is secured based on the security of its collection (if available) or the security of its source system specification as a fallback.

In some embodiments, the track-level security model puts a separate ACL (access control list) on every track and allows for significantly greater granularity. In certain embodiments, however, this makes the processing in this security mode slower. In some embodiments, the system 100 implements the security approach at each step of an observation's lifecycle, for example, being indexed, being searched, triggering an alert, and being live-rendered.

According to certain embodiments, the system 100 implements security at index time. In some embodiments, using the integration security model, when an observation is sent to the system, it already contains security-related information. In some examples, using this model, the security of an observation is derived from the source system. In certain embodiments, using TLS model, the observation carries a configuration (e.g., AclConfig) specifying its security. In some embodiments, if an observation does not carry a configuration in the TLS mode, it is considered globally visible. In certain embodiments, a search engine may use a TLS model.

According to certain embodiments, the system 100 implements security at search time. In some embodiments, the system 100 implements security at alert time. Using the integration security model, in certain embodiments, the system 100 secures an alert criterion based on the intersection of specifications that the subscribers can access. Using TLS model, in some embodiments, the system 100 creates a proxy token for each subscriber, gets the accessible ACL IDs for each of them, and sets the intersection as the security for the alert criterion.

According to some embodiments, the system 100 implements security at render time. In certain embodiments, feeds are secured on creation time. In some embodiments, feeds are secured either based on a set of integrations or a set of ACL IDs.

According to certain embodiments, the system 100 may implement two or more options for security, for example, configuration-based (e.g., ACLs, groups, classification, etc.) security, and resource-delegating security. In some embodiments, the configuration-based security is specified in the configuration in the source system specification. In certain embodiments, the configuration-based security may follow one or more standard security specifications. In some embodiments, the system 100 specifies security based on the classification. In certain embodiments, the system 100 uses the security of data to avoid maintaining the same data with different securities. In some embodiments, the system 100 may include one or more mandatory nodes used to enforce mandatory requirements and/or one or more discretionary nodes used to enforce group-based security.

According to some embodiments, for the resource-delegating security model, downstream datasets inherit mandatory requirements (e.g., classifications, markings) from upstream data and/or downstream datasets do not inherit discretionary requirements (e.g., read permissions, view permissions). In some embodiments, the system 100 can receive specified security at either the collection level or the source-system level. In certain embodiments, if a collection lacks security specification, the security is inherited from the source system: that is, when present, the collection security takes precedence over source system security.

According to certain embodiments, the system 100 can purge old data on a configurable schedule. In some embodiments, the system 100 can purge old data based on the storage system. In certain embodiments, the system 100 can purge old data by deletion by query. In some embodiments, the system 100 can log events of creating, modifying, and/or loading geotemporal data. In certain embodiments, certain high-volume logging events are excluded by default and may be enabled in configuration if desired. In some embodiments, logging is done using one or more system endpoints (e.g., proxy) of the system 100.

According to some embodiments, the system 100 allows streaming and/or batch ingestion. In certain embodiments, the system 100 supports two pathways to ingest data: the streaming pipeline and the batch pipeline. In some embodiments, both mechanisms will make data searchable and considered for alerting, but may have different purposes for different workloads. In some embodiments, the majority of geotemporal data flows through the streaming pipeline.

According to certain embodiments, the streaming pipeline uses all streaming architecture (e.g., Apache Kafka, Apache Flink), enabling fire-and-forget and low-latency ingest of data. For example, data enters this pipeline through a proxy or an endpoint which clients can sink to via the provided client system. In some embodiments, the streaming pipeline is suited for data with at least one of the following characteristics: high-scale, low-latency, and continuous. For example, ISR data points stream in at 30 or more points a second and are streamed continuously through non-vectorized layers (e.g., websockets) to the front-end so users can see the plane moving in near real-time.

In certain embodiments, due to the nature of streaming data, the system 100 may not store every point that comes in through the streaming pipeline: instead, the track can be down-sampled such that the system 100 does not lose the fidelity of the track. In some embodiments, the system 100 may ignore a point if it's within a threshold time (e.g., 10 seconds) in event time and/or within a threshold distance (e.g., 5 km) of the previous point. In some embodiments, the threshold time and/or the threshold distance can be configured per integration. In certain embodiments, the system 100 may only update the most-recent observation in a track at a pre-determined frequency (e.g., every 30 seconds of processing time). In some embodiments, the predetermined frequency is not configurable.

According to some embodiments, the batch pipeline synchronously sinks data to the system 100 making it slower than the asynchronous and distributed streaming pipeline. In certain embodiments, one or more client systems can sink data using the geotemporal-indexer service. In some embodiments, the batch pipeline is suited for data with at least one of the following characteristics: one-time imports of data, data that comes in batches, data where down-sampling points are unacceptable, data that requires immediate notice of invalidity (e.g., streaming will sink invalid data to a dead letter queue, while the batch pipeline will return the errant data). For example, BAS data comes in batches when a satellite image has been processed and doesn't require low latency delivery of messages, and thus uses the batch pipeline. In some embodiments, since data through the batch pipeline doesn't come in continuously, the batch pipeline does not support real-time streaming of data to the front-end through one or more non-vectorized layers (e.g., websockets), while support vector tiles.

As shown in FIG. 1, the system 100 for streaming, storing, and processing real-time data implements a system and method for user interface with manual geospatial correlation according to certain embodiments. In some examples, the system and method for user interface with manual geospatial correlation allows a user to see location data on a map and then manually associate the location data with an entity (e.g., a ship) and represent the entity's location accordingly. In other examples, the system and method for user interface with manual geospatial correlation provide a user interface that allows a user to start with location data and then link the location data to an entity that may or may not be on the map. For example, a sensor is outputting location data of Entity A from Source X, but the location data from Source X are not associated with an existing ID that has already been associated with location data about the same Entity A from Source Z. As an example, the user interface with manual geospatial correlation allows a user to manually correlate the location data from Source X with the existing ID that has already been associated with location data about the same Entity A from Source Z, and then to automatically update Entity A with the location data from Source X.

According to some embodiments, one or more users use at least one or more user interfaces with manual geospatial correlation to integrate and/or use geotemporal data in one or more workflows of the one or more users. For example, in certain operational contexts, location data is the foundation for building situational awareness around the world. As an example, being able to model the location data, secure the location data, see the location data, and/or combine the location data with one or more other data sources is important to at least some users' workflows.

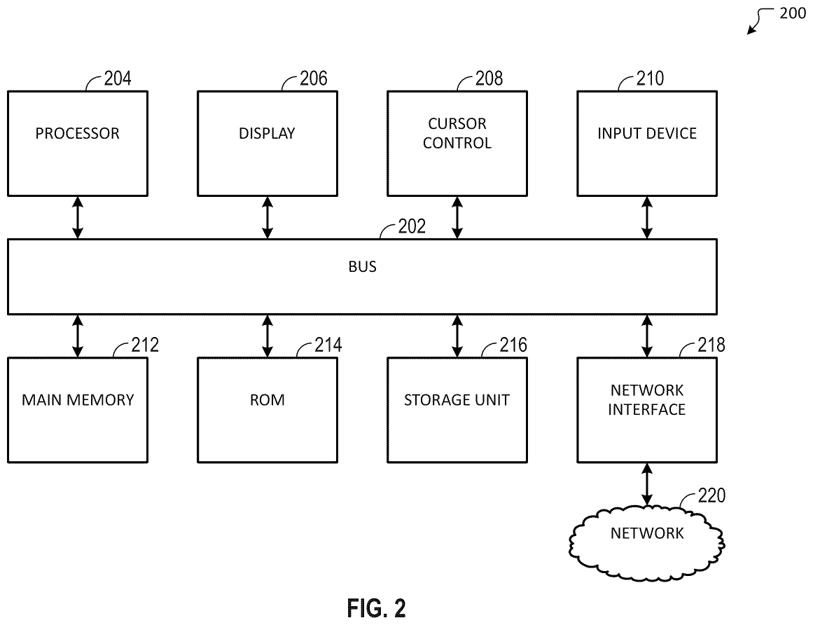

FIG. 2 is a simplified diagram showing a computing system for implementing one or more components or all components of the system 100 for streaming, storing, and processing real-time data in accordance with at least one example set forth in the disclosure. This diagram is merely an example. One of ordinary skill in the art would recognize many variations, alternatives, and modifications.

The computing system 200 includes a bus 202 or other communication mechanism for communicating information, a processor 204, a display 206, a cursor control component 208, an input device 210, a main memory 212, a read only memory (ROM) 214, a storage unit 216, and a network interface 218. In some examples, the bus 202 is coupled to the processor 204, the display 206, the cursor control component 208, the input device 210, the main memory 212, the read only memory (ROM) 214, the storage unit 216, and/or the network interface 218. In certain examples, the network interface 218 is coupled to a network 220. For example, the processor 204 includes one or more general purpose microprocessors. In some examples, the main memory 212 (e.g., random access memory (RAM), cache and/or other dynamic storage devices) is configured to store information and instructions to be executed by the processor 204. In certain examples, the main memory 212 is configured to store temporary variables or other intermediate information during execution of instructions to be executed by processor 204. For examples, the instructions, when stored in the storage unit 216 accessible to processor 204, render the computing system 200 into a special-purpose machine that is customized to perform the operations specified in the instructions. In some examples, the ROM 214 is configured to store static information and instructions for the processor 204. In certain examples, the storage unit 216 (e.g., a magnetic disk, optical disk, or flash drive) is configured to store information and instructions.

In some embodiments, the display 206 (e.g., a cathode ray tube (CRT), an LCD display, or a touch screen) is configured to display information to a user of the computing system 200. In some examples, the input device 210 (e.g., alphanumeric and other keys) is configured to communicate information and commands to the processor 204. For example, the cursor control component 208 (e.g., a mouse, a trackball, or cursor direction keys) is configured to communicate additional information and commands (e.g., to control cursor movements on the display 206) to the processor 204.

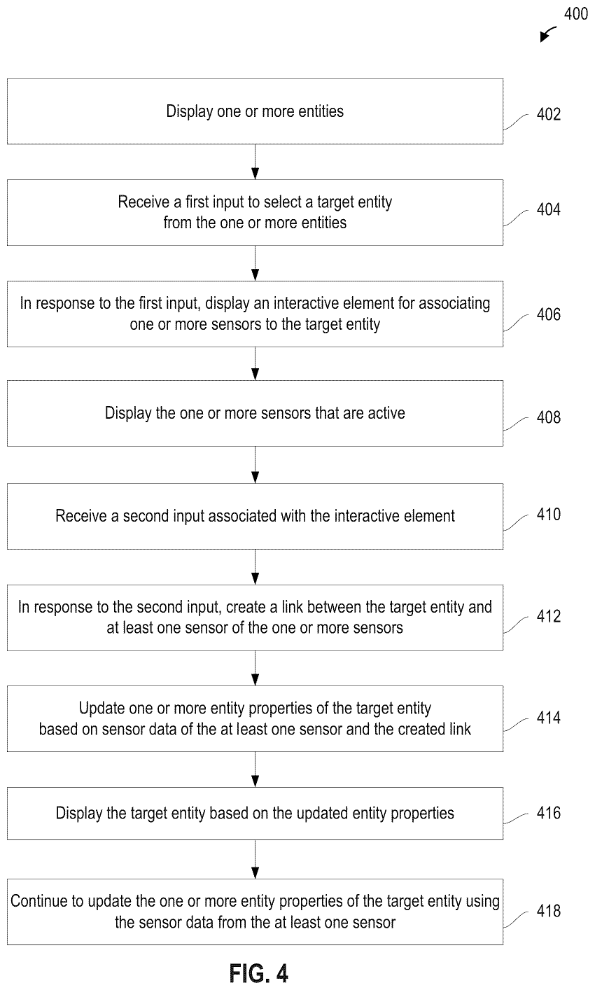

FIG. 4 is a simplified diagram showing a method for tracking a target entity by associating with sensor data according to one embodiment of the present invention. This diagram is merely an example, which should not unduly limit the scope of the claims. One of ordinary skill in the art would recognize many variations, alternatives, and modifications. The method 400 includes processes 402-418 that are performed using one or more processors. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced.

In some embodiments, some or all processes (e.g., steps) of the method 400 are performed by the system 200. In certain examples, some or all processes (e.g., steps) of the method 400 are performed by a computer and/or a processor directed by a code. For example, a computer includes a server computer (e.g., a correlation server/service) and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

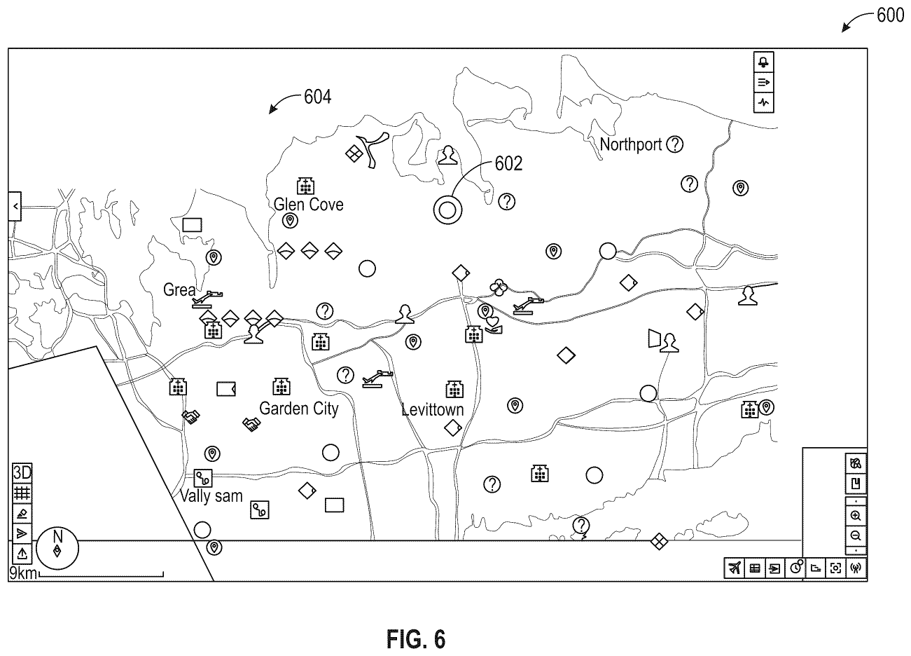

In some embodiments, at the process 402, one or more entities are displayed on a user interface. For example, FIG. 6 shows an exemplary display screen 600 configured to display an interactive map 604 with a plurality of entities to a user of the computing system 200. In some embodiments, the entity is an article, subject, object, person, being, creature, building, structure, or any existence that is detectable. In certain embodiments, each type of entity is represented with a different symbol. For example, an entity 602 represents an object (e.g., a vehicle, an object of interest). Upon selecting the entity 602, a floating window appears on the display screen (e.g., on the top right side) displaying information relevant to the selected object.

At the process 404, a first input is received to select a target entity from the one or more entities. For example, upon displaying the one or more entities on the user interface, a first input may be received from a user using an input device (e.g., 210) and/or a cursor control component (e.g., 208). For example, as shown in FIG. 6, a user may click on an entity 602 on an interactive map 604 to select an entity of interest. The first input indicates a target entity that the user wishes to select from the one or more entities.

According to some embodiments, the first input is a query received from a user. For example, a prompt may be received from the user and a large language model (LLM) may be used to generate a query based on the prompt. The prompt may include an entity description and/or a geographical area. The query may be applied to one or more data repositories having data associated with one or more entities. In response, an entity from the one or more entities is selected based on a query result.

At the process 406, in response to receiving the first input, an interactive element is displayed for associating one or more sensors to the target entity. For example, in some embodiments, the interactive element is a button, a drawing tool, or any interface element capable of receiving the first input.

For example, as described above, upon receiving the first input selecting the entity icon 602, a floating window associated with the selected entity 602 appears on the display screen. In some examples, the floating window includes an “Add correlation” interactive element, which allows the user to associate one or more sensors to the selected entity 602.

At the process 408, the one or more sensors that are active are displayed. According to some embodiments, the displayed one or more sensors include one or more sensors that are already associated with the target entity and one or more sensors that are active and/or available to be associated with the target entity. For example, referring back to the exemplary display screen in FIG. 6, when the user selects the interactive element, a list of one or more sensors that are active may be displayed. According to some embodiments, the list of one or more sensors that are displayed includes any sensors that are already associated with the selected entity 602. Additionally, the list of one or more sensors includes one or more sensors that are active and/or available to be associated with the selected entity 602.

At the process 410, a second input associated with the interactive element is received. The second input indicates at least one sensor from the one or more sensors that is selected by the user to be associated with the target entity. For example, a user may select a particular satellite to be correlated to the selected entity of interest. As described below, associating a sensor with the target entity allows the user to, for example, track the target entity using data from the associated sensor.

According to some embodiments, the second input is a query received from the user. For example, a prompt may be received from the user and a large language model (LLM) may be used to generate a query based on the prompt. The prompt may include a sensor description and/or a geographical area. The query may be applied to one or more data repositories having real-time sensor data collected by one or more sensors. In response, at least one sensor from the one or more sensors is selected based on a query result.

At the process 412, in response to receiving the second input, a link is created between the target entity and at least one sensor of the one or more sensors. For example, in some embodiments, the sensor is a camera, video, satellite, GPS receiver, radar, sonar, radio sensor, infrared sensor, thermal sensor, LIDAR, or any sensor that generates sensor data that may be used to extract data related to an entity. By linking the selected sensor to the target entity, sensor data of the selected sensor may be used to obtain information (e.g., entity properties) associated with the target entity.

At the process 414, one or more entity properties of the target entity are updated based on sensor data of the at least one sensor and the created link. For example, in some embodiments, the sensor data includes video data, image data, satellite imagery data, radar data, sonar data, radio signal data, GPS data, or any other sensor data generated by a sensor. In certain embodiments, the entity properties includes locations, positions, colors, shapes, features, characteristics, or any other attributes indicative of the target entity.

For example, sensor data of a particular satellite may include specific location data (e.g., latitude and longitude) of an entity of interest (e.g., the target object) at a specific time. The entity may be identified by an object detection model from an image that has been captured by the particular satellite. In such an example, entity properties of the target entity of interest (e.g., the target object) include location (e.g., latitude and longitude) of the target entity. The location (e.g., latitude and longitude) of the target entity of interest may be updated using the specific location data (e.g., latitude and longitude) of the target entity at the specific time that has been identified from an image captured by the particular satellite.

According to some embodiments, a set of correlation rules is applied to the sensor data of the at least one sensor and the one or more entity properties of the target entity to generate a correlation output. In some certain embodiments, the correlation rules indicate which entity properties to extract from the sensor data based on the selected entity and/or the type of sensor. For example, entity properties extracted from the sensor data for an entity may be different from entity properties extracted from the sensor data for an airplane. The correlation output is used to verify whether the at least one sensor correlates to the target entity.

If the verification succeeds, the sensor data of the at least one sensor is used to update the one or more entity properties of the target entity. However, if the verification fails, additional sensor data from the at least one sensor may be obtained in order to update the one or more entity properties of the target entity. For example, if a selected entity is an object but the entity properties extracted from the sensor data from an associated sensor do not include certain aspects or features of the object (e.g., not enough data), additional sensor data from the associated sensor is obtained for verification. In other words, the correlation output indicates whether one or more entity properties of the selected entity can be extracted from the sensor data received from the selected associated sensor. It should be appreciated that, according to some embodiments, one or more machine learning models may be used to generate a correlation output using the sensor data and the one or more entity properties of the target entity.

Additionally, according to some embodiments, multiple sensors may be associated with the target entity. In such embodiments, sensor data from the multiple sensors associated with the target entity may be received and the one or more entity properties of the target entity are determined based on the sensor data using a predetermined rule. The predetermined rule indicates which sensor data from the multiple sensors to be used to determine the entity properties of the target entity. For example, the predetermined rule indicates which sensor data to use when there is a conflict between sensor data from multiple sensors that are associated with the target entity. In other words, the predetermined rule may indicate which type of sensor data takes priority over other types of sensor data when multiple sensor data is received.

For example, when the target entity is associated with multiple sensors, multiple sensor data may be received from the multiple sensors. The sensor data may be different types of sensor data and may be received at different times. According to some embodiments, the sensor data may be prioritized based on a timestamp (e.g., use the most recent sensor data). According to certain embodiments, the sensor data is prioritized based on a predetermined ranking of the sensors. For example, the sensor data from a higher ranked sensor is used over the sensor data from a lower ranked sensor to update the entity properties.

At the process 416, the target entity is displayed based on the updated entity properties. For example, an updated location (e.g., latitude and longitude) of the target entity of interest is displayed on the interactive map (e.g., 604).

According to some embodiments, at the process 418, the one or more entity properties of the target entity is continued to be updated using the sensor data from the at least one sensor using the predetermined rule.

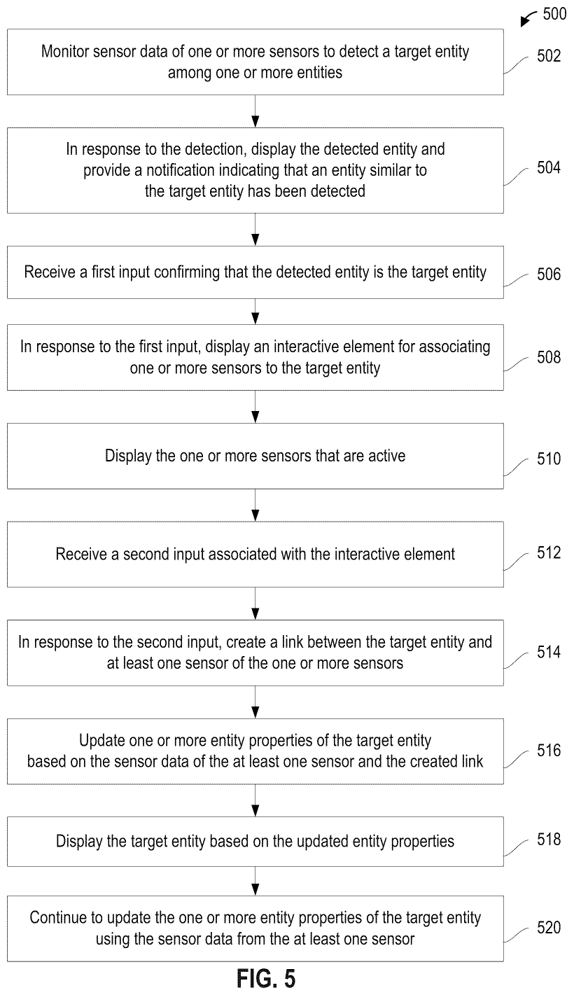

FIG. 5 is a simplified diagram showing a method for identifying and tracking a target entity by associating with sensor data according to one embodiment of the present invention. This diagram is merely an example, which should not unduly limit the scope of the claims. One of ordinary skill in the art would recognize many variations, alternatives, and modifications. The method 500 includes processes 502-520 that are performed using one or more processors. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced.

In some embodiments, some or all processes (e.g., steps) of the method 500 are performed by the system 200. In certain examples, some or all processes (e.g., steps) of the method 500 are performed by a computer and/or a processor directed by a code. For example, a computer includes a server computer (e.g., a correlation server/service) and/or a client computer (e.g., a personal computer). In some examples, some or all processes (e.g., steps) of the method 500 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

In some embodiments, at the process 502, sensor data of one or more sensors are monitored to detect a target entity among one or more entities. For example, the target entity is an entity of interest that a user is interested in identifying and tracking. To do so, one or more object recognition or detection algorithms (e.g., machine learning or deep learning) are used to detect a target entity of interest. In some embodiments, the entity is an article, subject, object, being, creature, building, structure, or any existence that is detectable, and/or the like. For example, a user may be interested in identifying a particular entity of interest. According to some embodiments, a query describing the target entity is received from a user. For example, a prompt may be received from the user and a large language model (LLM) may be used to generate a query based on the prompt. The prompt may include an entity description and/or a geographical area. The query may be applied to one or more data repositories having data associated with one or more entities. In response, an entity from the one or more entities is selected based on a query result. According to certain embodiments, a target entity may include one or more entities that are in a particular category of entities that the user is interest in (e.g., a target entity type). In such embodiments, the sensor data of one or more sensors are monitored to detect one or more entities that are of the target entity type.

At the process 504, in response to detection, the detected entity is displayed and a notification is provided. The notification indicates that an entity similar to the target entity has been detected. For example, FIG. 6 shows an exemplary display screen 600 configured to display an interactive map 604 with a plurality of entities to a user of the computing system 200. In some embodiments, each type of entity is represented with a different symbol. For example, upon detecting an entity that is similar to the entity of interest (e.g., the target object), the detected object 602 is displayed on an interactive map 604 of the display screen.

At the process 506, a first input is received confirming that the detected entity is the target entity. For example, upon displaying the detected entity on the interactive map 604, a first input may be received from a user using an input device (e.g., 210) and/or a cursor control component (e.g., 208). For example, as shown in FIG. 6, a user may click on a detected entity 602 on an interactive map 604 to confirm that the detected entity 602 is an entity of interest.

At the process 508, in response to receiving the first input, an interactive element is displayed for associating one or more sensors to the target entity. The one or more sensors are those sensors that generated the sensor data that triggered the detection of the entity that is similar to the target entity (e.g., the sensor data exhibited properties similar to the target entity) in the process 502. For example, in some embodiments, the interactive element is a button, a drawing tool, or any interface element capable of receiving the first input. For example, referring back to the exemplary display screen in FIG. 6, upon receiving the first input selecting the entity 602, a floating window associated with the selected entity 602 appears on the display screen (e.g., on the top right side) displaying information relevant to the selected object. The floating window further include an “Add correlation” interactive element, which allows the user to associate one or more sensors to the selected entity 602.

At the process 510, the one or more sensors that are active are displayed. According to some embodiments, the displayed one or more sensors include one or more sensors that are already associated with the target entity and one or more sensors that are active and available to be associated with the target entity. For example, referring back to the exemplary display screen in FIG. 6, when the user selects the interactive element, a list of one or more sensors that are active may be displayed. According to some embodiments, the list of one or more sensors that are displayed includes any sensors that are already associated with the target entity 602. Additionally, the list of one or more sensors includes one or more sensors that are active and available to be associated with the target entity 602.

At the process 512, a second input associated with the interactive element is received. The second input indicates at least one sensor from the one or more sensors that is selected by the user to be associated with the target entity. For example, a user may select a particular satellite to be correlated to the selected entity of interest. As described below, associating a sensor with the target entity allows the user to, for example, track the target entity using data from the associated sensor.

According to some embodiments, the second input is a query received from the user. For example, a prompt may be received from the user and a large language model (LLM) may be used to generate a query based on the prompt. The prompt may include a sensor description and/or a geographical area. The query may be applied to one or more data repositories having real-time sensor data collected by one or more sensors. In response, at least one sensor from the one or more sensors is selected based on a query result.

At the process 514, in response to receiving the second input, a link is created between the target entity and at least one sensor of the one or more sensors. For example, in some embodiments, the sensor is a camera, video, satellite, GPS receiver, radar, sonar, radio sensor, infrared sensor, thermal sensor, LIDAR, or any sensor that generates sensor data that may be used to extract data related to an entity. By linking the selected sensor to the target entity, sensor data of the selected sensor may be used to obtain information (e.g., entity properties) associated with the target entity.

At the process 516, one or more entity properties of the target entity are updated based on the sensor data of the at least one sensor and the created link. For example, in some embodiments, the sensor data includes video data, image data, satellite imagery data, radar data, sonar data, radio signal data, GPS data, or any other sensor data generated by a sensor. In certain embodiments, the entity properties include locations, positions, colors, shapes, features, characteristics, or any other attributes indicative of the target entity.

For example, sensor data of a particular satellite may include specific location data (e.g., latitude and longitude) of an entity of interest (e.g., the target entity) at a specific time. The object may be identified by an object detection model from an image that has been captured by the particular satellite. In such an example, entity properties of the target entity of interest (e.g., the target object) include location (e.g., latitude and longitude) of the target entity. The location (e.g., latitude and longitude) of the target entity of interest may be updated using the specific location data (e.g., latitude and longitude) of the target entity at the specific time that has been identified from an image captured by the particular satellite.

According to some embodiments, a set of preconfigured rules for each entity type is applied to the sensor data of the at least one sensor and the one or more entity properties of the target entity to generate a correlation output. In certain embodiments, the preconfigured rules indicate which entity properties to extract from the sensor data based on the detected entity (e.g., an entity type of the detected entity) and/or the type of sensor. For example, entity properties extracted from the sensor data for an object or a building may be different from entity properties extracted from the sensor data for an airplane. The correlation output is used to verify whether the at least one sensor correlates to the target entity.

If the verification succeeds, the sensor data of the at least one sensor is used to update the one or more entity properties of the target entity. However, if the verification fails, additional sensor data from the at least one sensor may be obtained in order to update the one or more entity properties of the target entity. For example, if a detected entity is an object but the entity properties extracted from the sensor data from an associated sensor do not include certain aspects or features of the object (e.g., not enough data), additional sensor data from the associated sensor is obtained for verification. In other words, the correlation output indicates whether one or more entity properties of the detected entity can be extracted from the sensor data received from the selected associated sensor. It should be appreciated that, according to some embodiments, one or more machine learning models may be used to generate a correlation output using the sensor data and the one or more entity properties of the target entity.

Additionally, according to some embodiments, multiple sensors are associated with the target entity. In such embodiments, sensor data from the multiple sensors associated with the target entity may be received and the one or more entity properties of the target entity are determined based on the sensor data using a predetermined rule. The predetermined rule indicates which sensor data from the multiple sensors to be used to determine the entity properties of the target entity. For example, the predetermined rule indicates which sensor data to use when there is a conflict between sensor data from multiple sensors that are associated with the target entity. In other words, the predetermined rule may indicate which type of sensor data takes priority over other types of sensor data when multiple sensor data is received.

For example, when the target entity is associated with multiple sensors, multiple sensor data may be received from the multiple sensors. The sensor data may be different types of sensor data and may be received at different times. According to some embodiments, the sensor data may be prioritized based on a timestamp (e.g., use the most recent sensor data). According to certain embodiments, the sensor data is prioritized based on a predetermined ranking of the sensors. For example, the sensor data from a higher ranked sensor is used over the sensor data from a lower ranked sensor to update the entity properties.

At the process 518, the target entity is displayed based on the updated entity properties. For example, an updated location (e.g., latitude and longitude) of the target entity of interest is displayed on the interactive map (e.g., 604).

At the process 520, the one or more entity properties of the target entity is updated using the sensor data from the at least one sensor using the predetermined rule.

According to some embodiments, if a piece of equipment (e.g., an entity) generates radio signals, a radio receiver (e.g., the sensor) receives the radio signals and geolocates the equipment based on where the radio signal is received from. If there are multiple receivers near the detected equipment, each receiver will receive and identify the equipment. Additionally, such receivers would be shown close to each other on the interactive map (e.g., 604). The user may choose to associate such receivers to the same military equipment. This ensure that same identifier is assigned to the same equipment. According to some embodiments, the user may choose to associate particular sensor data (e.g., a radio signal in this example) from selected sensors with the detected equipment. It should be appreciated that a user may select which entities and sensors to be shown on the interactive map. For example, the user may choose to show only the entities or only the sensors. In other example, the user may choose to show both the entities and sensors.

FIG. 6 illustrates an exemplary screenshot of a display screen for displaying and tracking one or more entities in accordance with at least one example set forth in the disclosure. This screenshot is merely an example. One of ordinary skill in the art would recognize many variations, alternatives, and modifications.

As shown in FIG. 6, the exemplary display screen 600 displays an interactive map 604 with a plurality of entities (e.g., 602) to a user of the computing system 200. In some embodiments, the entity is an article, subject, object, person, being, creature, building, structure, any existence that is detectable, and/or the like. As an example, each type of entity is represented with a different symbol. For example, an entity 602 represents an object. In some examples, when the entity 602 is selected, a floating window appears on the display screen (e.g., on the top right side) displaying information relevant to the selected object. In certain examples, the floating window further includes an “Add correlation” interactive element, which allows the user to associate one or more sensors to the selected entity 602. In some examples, when the user selects the interactive element, a list of one or more sensors that are active may be displayed. According to some embodiments, the list of one or more sensors that are displayed may include any sensors that are already associated with the selected entity 602. Additionally, in certain embodiments, the list of one or more sensors includes one or more sensors that are active and available to be associated with the selected entity 602. In certain embodiments, the exemplary interactive map 604 shows most recent locations of the plurality of entities. However, in some embodiments, the user may choose to show previous locations of one or more particular entities.

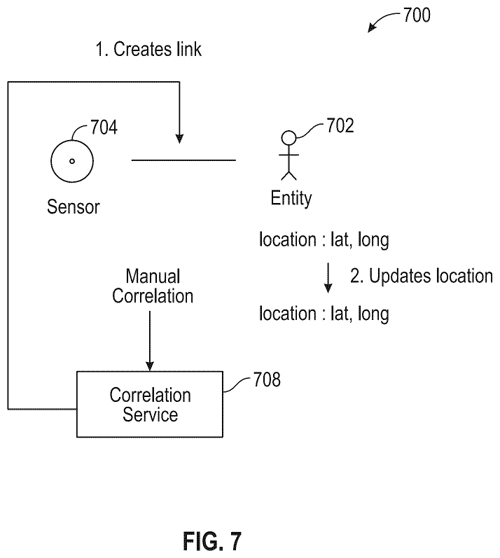

FIG. 7 is a simplified diagram showing a method for tracking an entity by creating a link between the entity and one or more sensors in accordance with at least one example set forth in the disclosure (e.g., methods 400 and 500 in FIGS. 4 and 5, respectively). This diagram is merely an example. One of ordinary skill in the art would recognize many variations, alternatives, and modifications.

For example, a user may select an entity of interest 702 and a sensor 704 to be correlated to the entity 702. As described above in FIGS. 4 and 5, upon selecting the entity 702 and the sensor 704, a link is created between the selected entity 702 and the sensor 704 by a correlation service 708 (e.g., a server system 140). For example, in some embodiments, the sensor is a camera, video, satellite, GPS receiver, radar, sonar, radio sensor, infrared sensor, thermal sensor, LIDAR, or any sensor that generates sensor data that may be used to extract data related to an entity. By linking the selected sensor 704 to the selected entity 702, sensor data of the selected sensor may be used to obtain information (e.g., entity properties) associated with the target entity. For example, in some embodiments, the sensor data includes video data, image data, satellite imagery data, radar data, sonar data, radio signal data, GPS data, or any other sensor data generated by a sensor. In certain embodiments, the entity properties include locations, positions, colors, shapes, features, characteristics, or any other attributes indicative of the target entity. In the example shown in FIG. 7, the entity property extracted from the sensor data from the selected sensor 704 is location (e.g., latitude and longitude) of the selected entity 702. The location of the selected entity 702 is updated based on the sensor data of the selected sensor 704.

According to certain embodiments, a method for tracking a target entity, the method comprising: displaying one or more indications of one or more entities, receiving a first input to select the target entity from the one or more entities, in response to receiving the first input, displaying an interactive element for associating one or more sensors to the target entity, displaying the one or more sensors that are active, receiving a second input associated with the interactive element, in response to receiving the second input, creating a link between the target entity and at least one sensor of the one or more sensors, and updating one or more entity properties of the target entity based on sensor data of the at least one sensor and the created link, wherein the method is performed using one or more processors. For example, the method is implemented according to at least FIG. 4 and/or FIG. 7.

In some embodiments, the method further comprises displaying the target entity based on the updated entity properties. In some embodiments, the method further comprises continuously updating the one or more entity properties of the target entity using the sensor data from the at least one sensor. In some embodiments, the displaying one or more indications of one or more entities comprises displaying the one or more indications overlaid on a map. In some embodiments, the interactive element comprises a button, a drawing tool, and an interface element that receives the second input.

In some embodiments, the second input comprises dragging the interactive element or making a section via the interactive element. In some embodiments, the at least one sensor is selected from the one or more sensors based at least in part on the second input. In some embodiments, the creating a link comprises linking an entity identifier of the target entity to the at least one sensor. In some embodiments, the method further comprises: applying a set of correlation rules to the sensor data and the one or more entity properties of the target entity to generate a correlation output, and verifying whether the at least one sensor correlates to the target entity based on the correlation output.

In some embodiments, the method further comprises if the verification fails, gathering additional sensor data from the at least one sensor. In some embodiments, the method further comprises applying one or more machine learning models to the sensor data and the one or more entity properties of the target entity to generate a correlation output, and verifying whether the at least one sensor correlates to the target entity based on the correlation output. In some embodiments, the method further comprises: receiving a prompt from a user, the prompt including at least one selected from a group consisting of a sensor description, a geographical area, and an entity description, generating a query by a large language model based on the prompt, applying the query to one or more data repositories having real-time sensor data collected by the one or more sensors, and selecting the at least one sensor from the one or more sensors based on a query result.

In some embodiments, the method further comprises: receiving a prompt from a user, the prompt including at least one selected from a group consisting of a sensor description, a geographical area, and an entity description, generating a query by a large language model based on the prompt, applying the query to one or more data repositories having data associated with one or more entities, and selecting the at least one sensor from the one or more sensors based on a query result. In some embodiments, the one or more entity properties include at least one of a location, color, shape, or any feature indicative of the target entity. In some embodiments, the method further comprises the sensor data includes at least one of video data, image data, satellite imagery data, sonar data, radio signal data, and GPS data.

In some embodiments, the method further comprises: receiving sensor data from one or more sensors associated with the target entity, and determining the one or more entity properties of the target entity based on the sensor data using a predetermined rule.

In some embodiments, the predetermined rule indicates which sensor data from the one or more sensors to be used to determine the entity properties of the target entity.

According to certain embodiments, a computing device for generating and managing a security level-aware map comprises a processor and a memory having a plurality of instructions stored thereon that, when executed by the processor, causes the computing device to display one or more indications of one or more entities, receive a first input to select the target entity from the one or more entities, in response to the first input, display an interactive element for associating one or more sensors to the target entity, display the one or more sensors that are active, receive a second input associated with the interactive element, in response to the second input, create a link between the target entity and at least one sensor of the one or more sensors, and update one or more entity properties of the target entity based on sensor data of the at least one sensor and the created link.

In some embodiments, wherein the plurality of instructions, when executed, further cause the computing device to display the target entity based on the updated entity properties. In some embodiments, wherein the plurality of instructions, when executed, further cause the computing device to continuously update the one or more entity properties of the target entity using the sensor data from the at least one sensor. In some embodiments, to display one or more indications of one or more entities comprises to display the one or more indications overlaid on a map. In some embodiments, the interactive element comprises a button, a drawing tool, and an interface element that receives the second input.

In some embodiments, the second input comprises dragging the interactive element or making a section via the interactive element. In some embodiments, the at least one sensor is selected from the one or more sensors based at least in part on the second input. In some embodiments, to create the link comprises to link an entity identifier of the target entity to the at least one sensor. In some embodiments, wherein the plurality of instructions, when executed, further cause the computing device to: apply a set of correlation rules to the sensor data and the one or more entity properties of the target entity to generate a correlation output, and verify whether the at least one sensor correlates to the target entity based on the correlation output.

In some embodiments, wherein the plurality of instructions, when executed, further cause the computing device to if the verification fails, gather additional sensor data from the at least one sensor. In some embodiments, wherein the plurality of instructions, when executed, further cause the computing device to: apply one or more machine learning models to the sensor data and the one or more entity properties of the target entity to generate a correlation output, and verify whether the at least one sensor correlates to the target entity based on the correlation output. In some embodiments, wherein the plurality of instructions, when executed, further cause the computing device to: receive a prompt from a user, the prompt including at least one selected from a group consisting of a sensor description, a geographical area, and an entity description, generating a query by a large language model based on the prompt, apply the query to one or more data repositories having real-time sensor data collected by the one or more sensors, and select the at least one sensor from the one or more sensors based on a query result.

In some embodiments, wherein the plurality of instructions, when executed, further cause the computing device to: receive a prompt from a user, the prompt including at least one selected from a group consisting of a sensor description, a geographical area, and an entity description, generating a query by a large language model based on the prompt, apply the query to one or more data repositories having data associated with one or more entities, and select the at least one sensor from the one or more sensors based on a query result. In some embodiments, the one or more entity properties include at least one of a location, color, shape, or any feature indicative of the target entity. In some embodiments, the sensor data includes at least one of video data, image data, satellite imagery data, sonar data, radio signal data, and GPS data.

In some embodiments, wherein the plurality of instructions, when executed, further cause the computing device to: receive sensor data from one or more sensors associated with the target entity, and determine the one or more entity properties of the target entity based on the sensor data using a predetermined rule. In some embodiments, the predetermined rule indicates which sensor data from the one or more sensors to be used to determine the entity properties of the target entity.

According to certain embodiments, a method for tracking a target entity, the method comprising: monitoring sensor data received from one or more sensors to detect the target entity among one or more entities, in response to the detection of an entity similar to the target entity based on sensor data received from at least one sensor of the one or more sensors, providing a notification indicating that the entity similar to the target entity has been detected, receiving a first input confirming that the detected entity is the target entity, in response to receiving the first input, displaying an interactive element for associating one or more sensors to the target entity, displaying the one or more sensors that are active, receiving a second input associated with the interactive element, in response to receiving the second input, creating a link between the target entity and at least one sensor of the one or more sensors, updating one or more entity properties of the target entity based on sensor data of the at least one sensor and the created link, wherein the method is performed using one or more processors. For example, the method is implemented according to at least FIG. 5 and/or FIG. 7.

In some embodiments, the providing the notification comprises displaying the sensor data received from at least one sensor of the one or more sensors. In some embodiments, the method further comprises: displaying the target entity based on the updated entity properties, and continuously updating the one or more entity properties of the target entity using the sensor data from the at least one sensor.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for tracking a target entity, the method comprising:
displaying one or more indications of one or more entities;
receiving a first input to select the target entity from the one or more entities;
in response to receiving the first input, displaying an interactive element for associating one or more sensors to the target entity;
displaying the one or more sensors that are active;
receiving a second input associated with the interactive element;
in response to receiving the second input, creating a link between the target entity and at least one sensor of the one or more sensors; and
updating one or more entity properties of the target entity based on sensor data of the at least one sensor and the created link;
wherein the method is performed using one or more processors.

2. The method of claim 1, further comprising:
displaying the target entity based on the updated entity properties.

3. The method of claim 1, further comprising:
continuously updating the one or more entity properties of the target entity using the sensor data from the at least one sensor.

4. The method of claim 1, wherein the displaying one or more indications of one or more entities comprises displaying the one or more indications overlaid on a map.

5. The method of claim 1, wherein the creating a link comprises linking an entity identifier of the target entity to the at least one sensor.

6. The method of claim 1, further comprising:
applying a set of correlation rules to the sensor data and the one or more entity properties of the target entity to generate a correlation output:
verifying whether the at least one sensor correlates to the target entity based on the correlation output; and
if the verification fails, gathering additional sensor data from the at least one sensor.

7. The method of claim 1, further comprising:
applying one or more machine learning models to the sensor data and the one or more entity properties of the target entity to generate a correlation output; and
verifying whether the at least one sensor correlates to the target entity based on the correlation output.

8. The method of claim 1, further comprising:
receiving a prompt from a user, the prompt including at least one selected from a group consisting of a sensor description, a geographical area, and an entity description:
generating a query by a large language model based on the prompt:
applying the query to one or more data repositories having real-time sensor data collected by the one or more sensors; and
selecting the at least one sensor from the one or more sensors based on a query result.

9. The method of claim 1, further comprising:
receiving a prompt from a user, the prompt including at least one selected from a group consisting of a sensor description, a geographical area, and an entity description:
generating a query by a large language model based on the prompt:
applying the query to one or more data repositories having data associated with one or more entities; and
selecting the at least one sensor from the one or more sensors based on a query result.

10. The method of claim 1, wherein the one or more entity properties include at least one of a location, color, shape, or any feature indicative of the target entity, and the sensor data includes at least one of video data, image data, satellite imagery data, sonar data, radio signal data, and GPS data.

11. The method of claim 1, wherein the updating one or more entity properties of the target entity based on sensor data of the at least one sensor comprises:
receiving sensor data from one or more sensors associated with the target entity; and
determining the one or more entity properties of the target entity based on the sensor data using a predetermined rule.

12. The method of claim 11, wherein the predetermined rule indicates which sensor data from the one or more sensors to be used to determine the entity properties of the target entity.

13. A computing device for tracking a target entity, the computing device comprising:
a processor; and
a memory having a plurality of instructions stored thereon that, when executed by the processor, causes the computing device to:
display one or more indications of one or more entities:
receive a first input to select the target entity from the one or more entities:
in response to the first input, display an interactive element for associating one or more sensors to the target entity:
display the one or more sensors that are active:
receive a second input associated with the interactive element:
in response to the second input, create a link between the target entity and at least one sensor of the one or more sensors; and
update one or more entity properties of the target entity based on sensor data of the at least one sensor and the created link.

14. The computing device of claim 13, wherein the plurality of instructions, when executed, further cause the computing device to:
apply a set of correlation rules to the sensor data and the one or more entity properties of the target entity to generate a correlation output:
verify whether the at least one sensor correlates to the target entity based on the correlation output; and
if the verification fails, gather additional sensor data from the at least one sensor.

15. The computing device of claim 13, wherein the plurality of instructions, when executed, further cause the computing device to:
apply one or more machine learning models to the sensor data and the one or more entity properties of the target entity to generate a correlation output; and
verify whether the at least one sensor correlates to the target entity based on the correlation output.

16. The computing device of claim 13, wherein the plurality of instructions, when executed, further cause the computing device to:
receiving a prompt from a user, the prompt including at least one selected from a group consisting of a sensor description, a geographical area, and an entity description:
generating a query by a large language model based on the prompt:
applying the query to one or more data repositories having real-time sensor data collected by the one or more sensors; and
selecting the at least one sensor from the one or more sensors based on a query result.

17. The computing device of claim 13, wherein to update the one or more entity properties of the target entity based on sensor data of the at least one sensor comprises to:
receive sensor data from one or more sensors associated with the target entity; and
determine the one or more entity properties of the target entity based on the sensor data using a predetermined rule,
wherein the predetermined rule indicates which sensor data from the one or more sensors to be used to determine the entity properties of the target entity.

18. A method for tracking a target entity, the method comprising:
monitoring sensor data received from one or more sensors to detect the target entity among one or more entities:
in response to the detection of an entity similar to the target entity based on sensor data received from at least one sensor of the one or more sensors, providing a notification indicating that the entity similar to the target entity has been detected:
receiving a first input confirming that the detected entity is the target entity:
in response to receiving the first input, displaying an interactive element for associating one or more sensors to the target entity:
displaying the one or more sensors that are active:
receiving a second input associated with the interactive element:
in response to receiving the second input, creating a link between the target entity and at least one sensor of the one or more sensors; and
updating one or more entity properties of the target entity based on sensor data of the at least one sensor and the created link:
wherein the method is performed using one or more processors.

19. The method of claim 18, wherein the providing the notification comprises displaying the sensor data received from at least one sensor of the one or more sensors.

20. The method of claim 18, further comprising:
displaying the target entity based on the updated entity properties; and
continuously updating the one or more entity properties of the target entity using the sensor data from the at least one sensor.
